(19) United States
(12) Patent Application Publication
(10) Pub. No.: US 2019/0154479 A1
(43) Pub. Date: May 23, 2019

(54) ESTIMATING FLOW VELOCITY IN PIPES BY CORRELATING MULTI-FREQUENCY SIGNALS

(71) Applicant: ExxonMobil Research and Engineering Company, Annandale, NJ (US)

(72) Inventors: Kenneth W. Desmond, Nazareth, PA (US); Gary L. Hunter, Stewartsville, NJ (US)

(21) Appl. No.: 16/190,734

(22) Filed: Nov. 14, 2018

Related U.S. Application Data
(60) Provisional application No. 62/587,679, filed on Nov. 17, 2017.

(51) Int. Cl. G01F 1/66; H04Q 9/12

(52) U.S. Cl. CPC G01F 1/66; H04Q 9/12

(57) ABSTRACT

Systems and methods are provided for estimating the flow velocity of a multi-phase flow using signals of different frequencies. The signals can correspond to any convenient type of signal that interacts with contrast agents in the multi-phase flow, such as acoustic signals or electromagnetic signals. The signal emitters can be located so that one emitter/receiver pair is downstream from a second pair by a separation distance. The receivers can preferably be located in sufficient alignment with the emitters to receive a transmitted portion of the emitter signal after any scattering or attenuation from the contrast agents in the multi-phase fluid. The emitters can be configured to generate signals of different frequencies. This can allow filters to be used on the received signals, so that the resulting filtered signal from the first receiver corresponds substantially to energy received from the first emitter, while the filtered signal from the second receiver corresponds substantially to energy received from the second emitter. The filtered signals can then be cross-correlated to determine a time shift that results in a maximum correlation. This time shift can be used in conjunction with the distance between the emitters to calculate an estimated flow velocity.

### CROSS-REFERENCE TO RELATED APPLICATIONS

This application claims priority to U.S. Provisional Application Ser. No. 62/587,679 filed Nov. 17, 2017, which is herein incorporated by reference in its entirety.

### FIELD

Systems and methods are provided for estimating the velocity of a multi-phase flow in a pipe or conduit based on correlation of signal intensities associated with signals of different to frequencies.

### BACKGROUND

Petroleum extraction methods generally include transport of a multi-phase flow through one or more pipes as oil is transported up to the surface and then passed to an initial storage and/or processing location at the extraction site. In addition to the desired hydrocarbons potentially including both gas phase and liquid phase portions, the multi-phase flow can also include entrained solids, other types of gas phase bubbles, and possibly multiple liquid phase regions due to the presence of non-hydrocarbon liquids (such as water) and/or incomplete mixing of hydrocarbons of different types/boiling ranges. During oil extraction, it can be desirable to characterize the flow rate within the pipes or other conduits used for transporting the extracted hydrocarbons. This can include characterizing the overall flow rate generated by one or more oil wells (or other extraction sites) and/or characterizing the flow rate in different zones within a single extraction site.

Conventionally, characterization of the flow rate is performed by periodically (e.g. every couple of months) diverting flow from a co-mingled collection of wells to a settling tank to determine the phase fractions and production rates. In addition to providing information about only the final co-mingled product, the time scale of waiting multiple weeks or months between characterization events can present difficulties when attempting to optimize production from a given well and/or a given zone within an extraction site.

As an alternative to diverting flows into a storage tank, conventional flow meters can be employed that are calibrated for expected operating conditions (e.g. temperature, flow composition, and flow morphology). Despite the calibrations, these flow meters are often inaccurate when compared to direct measurements. Additionally, deployment of many commercially available meters requires a section of pipe be removed and replaced with a specially designed pipe, making use of such flow meters in existing pipelines prohibitive from a cost standpoint.

Still other alternatives for determining a flow velocity can be based on methods that involve substantial training for the operator and/or specialized equipment that is typically more suited for laboratory use. For example, nuclear magnetic resonance (NMR) imaging or gamma ray imaging can be used to determine a flow rate within a pipe or conduit. However, both of these techniques require substantial operator expertise to perform the measurement and analyze the data. Additionally, the equipment required for these measurements can be difficult to adapt to the environment at an extraction site.

What is needed are methods for determining the flow rate of a multi-phase flow within a pipe, and corresponding systems to facilitate such methods. The methods can preferably be performed and/or the systems can preferably be installed and used without requiring replacement of a section of the pipe to allow for insertion of a sensor. Additionally, the methods can preferably be performed and/or the systems can preferably be used without requiring substantial training of an operator. Further, the systems and methods can preferably allow for characterization of the flow velocity of a multi-phase flow in spite of the potentially unpredictable composition and/or characteristics of the multi-phase flow.

U.S. Patent Application Publication 2013/0238260 describes an ultrasonic flow meter that measures a flow volume of a primarily single phase fluid by sending an ultrasonic signal to the fluid and receiving a transmission signal or a reflection signal obtained from the fluid. The received transmission signal can be used to determine a first flow volume while the reflection signal can be used to determine a second flow volume. The first flow volume or second flow volume can then be selected for output to the user based on a volume of air bubbles in the fluid, as determined by a correcting unit.

U.S. Patent Application Publication 2014/0096599 describes a method and apparatus for determining a flow rate of a fluid and detecting gas bubbles or particles in the fluid. The gas bubbles or particles are detected based on a collapse of an amplitude of an ultrasonic signal. The flow rate can be determined based on a travel time of the ultrasonic signal in the fluid. A plurality of transmitters and receivers can be used to allow for averaging of a plurality of determined flow rates in order to reduce errors in the flow rate determination.

U.S. Pat. No. 4,545,244 describes a method and apparatus for using a pair of transducers to determine a flow rate in a fluid. In some aspects, the transducers can be configured so that one is upstream relative to the other to allow for a measurement of flow rate based on both a Doppler shift and a time of propagation for an ultrasonic wave.

An article by R. Velmurugan et al. in the International Journal of Computer Applications (Vol. 66, No. 10, Mar. 2013) describes an ultrasonic flow meter using a cross-correlation technique. Two pairs of ultrasonic transducers are used that operate at the same frequency. The signals transmitted through the fluid are detected and then correlated using a cross-correlation technique to determine the time shift between the detected signals that corresponds to the highest correlation. As noted in the journal article, clamp-on transducers are not preferred for this type of system. This is due to restrictions on the dynamic range of a clamp-on flow meter due to acoustic short circuits between the ultrasonic transmitters and demodulator. The journal article states that in a continuous wave cross-correlation meter, the sensors must be acoustically isolated from the pipe walls to eliminate the short-circuit effect, which usually excludes the use of a clamp-on arrangement. Additionally, clamp-on transducers also have the difficulties due to the dependence of beam spacing and orientation on acoustic transmission through pipe walls, where imperfections distort and refract the beams.

### SUMMARY

In various aspects, a method is provided for estimating a flow velocity of a multi-phase flow. An example of a multi-phase flow is a flow that includes a liquid phase and at least one of gas bubbles, solid particles, and an immiscible second liquid phase. The method can include transmitting, by a first emitter, a first signal into a multi-phase flow. The first signal can have a frequency f+δ. Examples of suitable emitters include emitters for generating electromagnetic signals and transducers for generating ultrasonic signals. A first receiver can receive a signal comprising a portion of the first signal transmitted through the multi-phase flow. This first received signal can then be passed through a first filter to form a first filtered signal. Optionally, the first filter can be configured for exclusion of signal having a frequency f−δ from the first filtered signal and configured for inclusion of signal having a frequency f+δ in the first filtered signal. Examples of suitable filters can include band-pass filters, notch filters, and lock-in filters. The method can also include transmitting, by a second emitter, a second signal into the multi-phase flow. The second signal can have a frequency f−δ. The first emitter and the second emitter can be separated by a separation distance. A second receiver can receive a portion of the second signal transmitted through the multi-phase flow. This second received signal can be passed through a second filter to form a second filtered signal. Optionally, the second filter can be configured for exclusion of signal having a frequency f+δ from the second filtered signal and configured for inclusion of signal having a frequency f−δ in the second filtered signal. The first filtered signal can be cross-correlated with the second filtered signal to determine a time shift corresponding to a maximum correlation between the first filtered signal and the second filtered signal. Based on the separation distance and the determined time shift, a flow velocity of the multi-phase flow can be estimated.

In various aspects, the first emitter and the second emitter can be mounted in any convenient location that allows for characterization of a desired multi-phase flow. For example, the first emitter and second emitter can be mounted within a pipe and/or on the exterior of a pipe. Transducers are an example of an emitter that can be suitable for use with emitters and receivers that are mounted on an exterior of a pipe. In some aspects where the multi-phase flow represents a flow within a vessel and is not defined by a pipe, the first emitter and/or the second emitter can be mounted within the vessel. Optionally, the second receiver can have substantially the same alignment relative to the second emitter as the alignment of the first receiver relative to the first emitter. Preferably, the alignment of the emitters and receivers can be selected so that the portion of the first signal/second signal transmitted through the multi-phase flow comprises a portion of the first signal/second signal that has interacted with one or more contrast agents within the multi-phase flow.

In various aspects, a magnitude of δ can correspond to 0.01% to 50% of a magnitude of f. In aspects where the emitters correspond to transducers, f+δ and/or f−δ can correspond to frequencies between 20 kHz and 100 MHz.

In some aspects, cross-correlation of the first filtered signal and the second filtered signal can include dividing the first filtered signal into a first plurality of time windows and dividing the second filtered signal into a second plurality of time windows. One or more time windows from the first plurality of time windows can then be cross-correlated with one or more corresponding time windows from the second plurality of time windows to generate a series of estimated flow velocities. Optionally, at least one time window from the first plurality of time windows can overlap in time with at least a second time window from the first plurality of time windows. Optionally, dividing locations in the second plurality of time windows can be offset from dividing locations in the first plurality of time windows.

In various aspects, a system for estimating a flow velocity of a multi-phase flow is provided. The system can include a first emitter mounted in a first position relative to a pipe or vessel for containing a multi-phase fluid flow. The first emitter can be configured to generate a first signal having a frequency f+δ. The system can further include a first receiver mounted in a second position relative to the pipe or vessel for receiving at least a portion of the first signal. The system can further include a second emitter mounted in a third position relative to the pipe or vessel. The second emitter can be mounted at a separation distance from the first emitter. The second emitter can be configured to generate a second ultrasonic signal having a frequency f−δ. The system can further include a second receiver mounted in a fourth position relative to the pipe or vessel for receiving at least a portion of the second signal. The system can further include a first filter in signal communication with the first receiver to form a first filtered signal. For example, the first filter can be configured for exclusion of signal having a frequency f−δ from the first filtered signal and configured for inclusion of signal having a frequency f+δ in the first filtered signal. The system can further include second filter in signal communication with the second receiver to form a second filtered signal. For example, the second filter being configured for exclusion of signal having a frequency f+δ from the second filtered signal and configured for inclusion of signal having a frequency f−δ in the second filtered signal. The system can further include a correlator for determining a time shift based on cross-correlation of the first filtered signal and the second filtered signal.

### BRIEF DESCRIPTION OF THE DRAWINGS

FIG. 1 schematically shows an example of a system for measuring a flow velocity in a pipe using ultrasonic signals generated by transducers external to the pipe.

FIG. 2 shows a process flow for measuring a flow velocity in a pipe using ultrasonic signals generated by transducers external to the pipe.

FIG. 3 shows an example of processed signal intensities from ultrasonic signals generated by transducers external to a pipe.

FIG. 4 shows an example of performing cross-correlation on the processed signal intensities shown in FIG. 3.

FIG. 5 shows an example of an average flow rate within a pipe determined based on the time shift corresponding to the maximum in correlated intensity in FIG. 4.

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, systems and methods are provided for estimating the flow velocity of a multi-phase flow using signals of different frequencies. The signals can correspond to any convenient type of signal that interacts with contrast agents in the multi-phase flow, such as acoustic signals or electromagnetic signals. The contrast agents can correspond to any feature in the multi-phase flow that can interact with the emitted signal to provide attenuation and/or scattering that differs from the interaction provided by the bulk flow of the continuous liquid phase. Examples of contrast agents can include, but are not limited to, bubbles, solid particles, and a second immiscible liquid phase. The signal emitters can be located so that one emitter/receiver pair is downstream from a second pair by a separation distance. The receivers can preferably be located in sufficient alignment with the emitters to receive a transmitted portion of the emitter signal after any scattering or attenuation from the various phases (i.e., contrast agents) in the multi-phase fluid. The emitters can be configured to generate signals of different frequencies. This can allow filters to be used on the received signals, such as a band-pass filter, a notch filter, or a lock-in filter (i.e., a filter including a lock-in amplifier), so that the resulting filtered signal from the first receiver corresponds substantially to energy received from the first emitter, while the filtered signal from the second receiver corresponds substantially to energy received from the second emitter. The filtered signals can then be cross-correlated to determine a time shift that results in a maximum correlation. This time shift can be used in conjunction with the distance between the emitters to calculate an estimated flow velocity.

Attempting to measure and/or estimate the flow velocity of a multi-phase flow using a simple, non-intrusive method can pose a variety of challenges. For example, the unpredictable nature of the multi-phase flow can present difficulties in attempting to interpret the time-varying response of signals. One option for overcoming the difficulties due to inconsistent time-varying response in a multi-phase flow can be to use a cross-correlation technique. In a cross-correlation measurement, two pairs of emitters and receivers can be used, with one emitter/receiver pair located upstream from the second emitter/receiver pair. Instead of attempting to interpret a time-varying response of the flow, the changes in transmission as the signal passes through at least a portion of the multi-phase flow can be monitored. These changes in transmission can then be monitored under the assumption that, if the distance between the emitters is small enough, the multi-phase flow may not change substantially between the locations of the emitters. Under the assumptions that a similar composition and structure of the multi-phase flow will produce a similar response, and that the structure of the multi-phase flow (such as the position of various particles/phases within the flow) does not change significantly between the locations of the emitters, the signals from the two emitter/receiver pairs can be cross-correlated to determine the length of time required for a cross-section of the flow in the pipe to travel from the plane of the first emitter/receiver pair to the plane of the second emitter/receiver pair.

Although cross-correlation of signals is known, difficulties remain in attempting to use cross-correlation for determining velocity in multi-phase flows. For example, in aspects where the signals correspond to ultrasonic signals, some difficulties can be related to the nature of how transducers produce ultrasonic signals. Transducers typically emit ultrasonic energy in an arc or cone rather than in a narrow beam, meaning that if the receivers are too close together, a portion of the signal from both transducers will arrive at each receiver. This can be further compounded by scattering from the various phases in the multi-phase flow. Moving the transducers farther apart can help to isolate the signals received by each receiver, but increasing the separation distance between the transducers carries a corresponding risk of increasing the likelihood that the structure of the multi-phase flow will change during the additional time required to travel the distance between the transducers. Such changes in the structure of the multi-phase flow may arise from many effects, including, but not limited to, non-uniform laminar flow, turbulent mixing, gravitational or centrifugal separation, dissolution or precipitation of media, diffusion, etc.

In order to overcome the difficulties with a cross-correlation system when measuring a multi-phase flow, the emitters can be configured to generate signals of different frequencies. Without being bound by any particular theory, it is believed that a majority of the signal attenuation caused by a multi-phase flow can be roughly frequency independent. By using sufficiently different frequencies, the energy received at the receivers can be distinguished based on frequency. This can allow for processing of the received signals using filters, such as band-pass filters, notch filters, lock-in filters, and/or any other convenient type of filter that allows a desired frequency to be received while excluding one or more other frequencies. For example, one emitter can have a filter that allows passage of a limited range of frequencies roughly centered on a frequency f+δ, while a second emitter can have a filter that allows passage of a limited range of frequencies roughly centered on a frequency f−δ. This can allow the final filtered signals to be isolated so that the final filtered signal substantially corresponds to only received signal from the desired emitter, independent of the separation distance between the emitters and/or receivers.

In this discussion, the term “pipe” is used to refer to any convenient type of conduit between the locations of the transducer/receiver pairs. The wall of the pipe can be made of any convenient material that allows for sufficient transmission of ultrasonic energy. For convenience, some aspects of the methods and systems described herein are described in relation to flows within a pipe. While this provides a convenient frame of reference for illustrating the nature of the methods and systems, having a physically defined conduit for a flow is not required.

In some aspects, the emitter/receiver pairs can be used to estimate a flow velocity for a flow that is not confined within a pipe. The methods described herein can be used to estimate a flow velocity for any multi-phase flow that has a (reasonably) well-defined flow pattern. For example, a sufficiently large vessel may have various well-defined flow patterns within the vessel. In such a vessel, pairs of emitters and receivers can be mounted within the vessel at convenient locations for characterizing a portion of the flow within the vessel. In this discussion, mounting an emitter and/or receiver can correspond to any convenient method of holding an emitter or receiver in a desired location for interacting with a multi-phase flow. Depending on the aspect, mounting of an emitter and/or receiver can correspond to: attaching an emitter and/or receiver to an exterior surface of a pipe or vessel; attaching an emitter and/or receiver to an interior surface of a pipe or vessel; suspending an emitter and/or receiver at a location within a pipe or vessel, such as by attaching the emitter and/or receiver to a structure that protrudes from a wall of the pipe or vessel to the mounting location; or any other convenient method for maintaining an emitter and/or receiver in a desired location.

### Emitter and Receiver Configuration

In various aspects, the orientation of an emitter/receiver pair relative to the axis of fluid flow can be any convenient orientation that allows for interaction of the emitted radiation with contrast agents in the multi-phase flow. In other words, at least a portion of the signal received by the second receiver has interacted with the multi-phase flow at a location downstream from at least a portion of the signal received by the first receiver. Additionally, a second emitter/receiver pair can be located and oriented relative to a first emitter/receiver pair so that the second emitter/receiver pair is downstream from the first emitter/receiver pair. It is noted that configurations where the emitter and receiver are located within the flow are not preferred, as this would introduce a disruption into the flow that is being characterized.

In various aspects, the emitters can emit signals at different frequencies. Band-pass filters, lock-in filters, notch filters, and/or other types of filters can allow the receivers to receive a signal based on the emitter associated with the receiver while reducing, minimizing, or eliminating signal based on the emitter not associated with the receiver. Based on the arrangement of the emitters and receivers, the received signals can be cross-correlated to determine a time shift that produces a maximum correlation. The flow velocity in the pipe can then be estimated as the distance between the emitters divided by the time shift.

During a measurement, a first emitter can generate a signal at a first frequency. A first receiver can be aligned to receive a portion of the generated signal from the first emitter. It is not required that the first emitter and first receiver are diametrically opposed. Instead, any convenient alignment for the first emitter and the first receiver can be suitable, so long as the alignment of the first emitter and the first receiver allows the first receiver to receive a portion of the signal from the first emitter that has interacted with contrast agents in the multi-phase flow. In some aspects, the first receiver can be located within the arc or cone of transmission for the first emitter. In other aspects, the first receiver can be located in a position that is convenient for receiving a scattered signal from the first emitter, such as a back-scattered signal.

During a measurement, a second emitter can be located downstream from the first emitter by a small distance and/or a second receiver can be located downstream from the first receiver by a small distance. The second emitter can generate a signal at a second frequency different from the first frequency. Similar to the first emitter and first receiver, a wide variety of alignments can be suitable for the second emitter and second receiver. In some aspects, the orientation of the second receiver relative to the second emitter can be substantially the same as the orientation of the first receiver relative to the first emitter. In other words, the location of the second receiver on the pipe relative to the second emitter can be similar to the location relationship of the first receiver and the first emitter. In other aspects, the orientation of the second receiver relative to the second emitter can be any convenient orientation relative to the first emitter/receiver pair. As long as the relative orientations of the first emitter/receiver pair and the second emitter/receiver pair are known, any differences in the orientation can be accounted for when determining the time shift for cross-correlation.

The received signal from both the first receiver and the second receiver can then be passed through filters. This can allow any signal generated by the second emitter to be filtered out of the signal received by the first receiver, while any signal generated by the first emitter can be filtered out of the signal received by the second receiver. For example, for any two frequencies f₁ and f₂, the frequencies can alternatively be expressed as f+/−δ. If f₁ corresponds to f+δ, then f₂ can correspond to f−δ. If the value of δ is sufficiently large, a first filter can be used to filter out f₁ while passing through f₂ for one of the receivers, while similarly a second filter can be used to filter out f₂ while passing through f₁ for the second receiver. In some aspects, this can correspond to filtering out all frequencies above or below a threshold value. In other aspects, the filter can allow a range of frequencies to pass through, with the range roughly centered on the desired frequency (i.e., roughly centered on either f−δ or f+δ. In such aspects, the magnitude of δ can preferably be greater than the filtering window of the filter. It is noted that δ can be negative, so f−δ can potentially correspond to the higher frequency.

In some aspects, the emitters can correspond to transducers and the emitted frequencies emitted can correspond to ultrasonic frequencies. In this discussion, ultrasonic frequencies correspond to frequencies from 20 kHz to 100 MHz. In some aspects, the ultrasonic frequencies can be between 100 kHz and 100 MHz. Preferably, both f+δ and f−δ can correspond to frequencies within 20 kHz to 100 MHz, or within 100 kHz to 100 MHz. The corresponding wavelength for an ultrasonic signal can vary depending on the nature of the multi-phase flow. The speed of sound in various typical liquids (such as diesel fuel or water) can be roughly 1600 m/s or less. At 1600 m/s, 20 kHz can correspond to a wavelength of 8.0 cm; 100 kHz can correspond to a wavelength of 1.6 cm; 100 MHz can correspond to a wavelength of 0.16 mm or 160 μm; and 100 MHz can correspond to a wavelength of 8.0 μm. However, it is noted that bitumen and/or other heavy petroleum fractions can in some instances have energy transfer properties that are more similar to an amorphous solid than a liquid, resulting in potential speed of sound values up to 2500 m/s or possibly still higher. This type of increase in the speed of sound for a multi-phase flow can potentially roughly double the corresponding wavelength for a given ultrasonic frequency.

In some aspects, the emitters can correspond to electromagnetic emitters, with the emitted signals corresponding to electromagnetic signals. For aspects involving emitting and receiving electromagnetic signals, the desired frequency for the signals can be dependent on the nature of the contrast agents being detected. Depending on the nature of the contrast agent, the frequency for the electromagnetic signals can be selected based on the size of the contrast agents, one or more dielectric properties of the contrast agents, a magnetic property of the contrast agent, or any other property that allows for a detectable interaction with the electromagnetic signal.

Based on the use of the filters which allow the receivers to process substantially only the signal from the desired emitter, the emitters can be located as close together as is practical. The separation distance between two emitters can be defined as the distance between the geometric center of the emitters along a direction parallel to the fluid flow axis, such as the fluid flow axis of a pipe containing the fluid flow. The minimum separation distance between emitters is limited only by the physical size of the devices and any additional separation, potentially small or non-existent, necessary to ensure the operation of a given emitter does not substantially interfere with another.

For aspects involving transducers as the emitters, the frequency of the ultrasonic radiation can also be selected so that the corresponding wavelength of the radiation is sufficiently small relative to the size of the pipe. In various aspects, the diameter of the pipe can be at least 1 times greater than the wavelength corresponding to the smaller off−δ and f+δ, or at least 5 times greater, or at least 10 times greater. Typical pipe diameters for petroleum extraction applications can range from 3.0 cm to 40 cm, or 10 cm to 30 cm. Thus, corresponding suitable maximum wavelengths can be from 0.6 cm to 8.0 cm, or 0.3 cm to 4.0 cm, or 2.0 cm to 6.0 cm, or 1.0 cm to 3.0 cm.

The magnitude of δ for selecting f+δ and f−δ can be any convenient size that can be effectively filtered using a conventionally available filter, such as a band-pass filter, notch filter, or a filter including a lock-in amplifier (referred to herein as a lock-in filter). If digital band-pass filtering and/or lock-in filtering is available, smaller magnitudes for δ can be used. The magnitude of δ may be chosen as small or large as desired such that the frequencies f+δ and f−δ remain practically distinguishable with filters or other processing methods. In some aspects related to using transducer/receiver pairs to emit/receive ultrasonic frequencies, the magnitude of δ can be at least 0.1% of the value off or at least 10%, or at least 20%, such as 5% to 50% of the value of f (or possibly still more), or 5% to 30% of the value off. In some aspects, 8 can have a smaller magnitude corresponding to at least 0.01% of the value off, or at least 0.1%, or at least 1.0%. For example, the magnitude of δ can be 0.01% to 50% off or 1% to 50%, or 0.01% to 25%, or 0.01% to 10%, or 1.0% to 25%, or 1.0% to 10%. In some aspects, it may be beneficial to have a smaller value of delta, in order to reduce or minimize differences in the attenuation/scattering behavior of the ultrasonic signals as the signals interact with a multi-phase flow.

In aspects relative to using emitter/receiver pairs to emit/receive electromagnetic signals, the larger potential frequencies that may be suitable can allow for smaller values of 6. For example, the magnitude of δ can be 0.01% to 50% off or 0.1% to 50%, or 0.01% to 25%, or 0.01% to 10%, or 0.1% to 25%, or 0.1% to 10%

The amplitude of the emitted signals can be any convenient amplitude that allows the receiver to distinguish between emitted signal passing through the multi-phase flow and the noise floor. In particular, the distinction between the signals and the noise floor needs to be sufficient to allow for cross-correlation of the received signals to determine a time shift corresponding to a maximum correlation.

After filtering, the first filtered signal and the second filtered signal can be cross-correlated to identify a time shift that produces a maximum correlation between the filtered signals. The time shift corresponding to a maximum correlation can represent the length of time required for a portion of the multi-phase flow to move the plane of the first emitter/receiver pair to the plane of the second emitter/receiver pair. The distance between the emitters divided by the time shift can provide an estimate of the flow velocity.

The cross-correlation of the signal from the first receiver and the second receiver can be performed in any convenient manner. Commercial packages are available that can allow for determining a time shift between signals to identify a time shift corresponding to a maximum similarity between the signals.

In some aspects, it may be desirable to develop a profile of flow velocity estimates over time, as opposed to simply calculating a single velocity estimate. Obtaining and handling the data to determine flow velocity estimates as a function of time can be performed in any convenient manner. One option can be to use synchronous pulses of emitted energy from each emitter. Each synchronized pulse can be used to perform a separate cross-correlation to determine a flow velocity estimate. Another option can be to continuously transmit the ultrasonic energy and divide the received data into windows by any convenient method. When dividing data into windows, it may optionally be preferred to offset the data windows for the second receiver by an amount less than the expected time shift during cross-correlation, in order to increase the amount of data available in each data window for cross-correlation. Optionally, such an increase in available data can also be facilitated by allowing the data windows to overlap.

### CONFIGURATION EXAMPLES

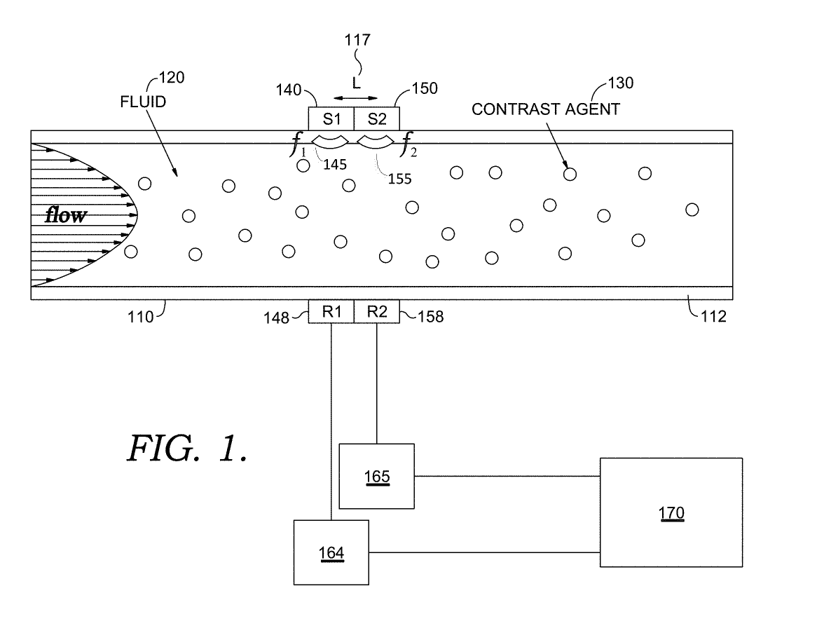

FIG. 1 shows an example of a configuration for using cross-correlation of emitted signals to estimate a flow velocity in a pipe. In the example shown in FIG. 1, the emitters correspond to transducers. In FIG. 1, a pipe 110 contains a multi-phase fluid flow that includes both fluid 120 and contrast agents 130. In order to qualify as a multi-phase flow, at least some contrast agents 130 can correspond to phases that are different from the phase of fluid 120, such as gas bubble and/or solid particle contrast agents when fluid 120 is a liquid. Optionally, some contrast agents 130 can also correspond to alternative liquid phases when fluid 120 is a liquid, such as water droplets in a hydrocarbon liquid and/or insoluble heavy oil phases in a lower boiling liquid. Transducers 140 and 150 can be mounted externally on pipe wall 112 of pipe 110. Corresponding receivers 148 and 158 can also be mounted externally on pipe wall 112. The separation between transducer 140 and transducer 150 corresponds to a length 117. Transducer 140 can emit an ultrasonic signal 145 at a frequency f+δ that passes through the multi-phase flow and is received by receiver 148. Similarly, transducer 150 can emit an ultrasonic signal 155 at a frequency f−δ that passes through the multi-phase flow and is received by receiver 158. It is noted that δ can be either positive or negative, so the higher frequency signal can be either ultrasonic signal 145 or ultrasonic signal 155. The signals received at receiver 148 and receiver 158 can be attenuated and/or scattered at least in part by the various contrast agents 130 in the fluid 120. The signal received at receiver 148 can then be filtered using a filter 164 to produce a filtered signal that includes frequencies near f+δ and excludes frequencies near f−δ. The signal received at receiver 158 can be filtered using a filter 165 to produce a filtered signal that includes frequencies near f−δ and excludes frequencies near f+δ. The filtered signals can then be cross-correlated in a correlator 170 to determine a time shift i between the signals that produces a maximum correlation. The velocity of the multi-phase flow in the pipe 110 can then be estimated as L/τ.

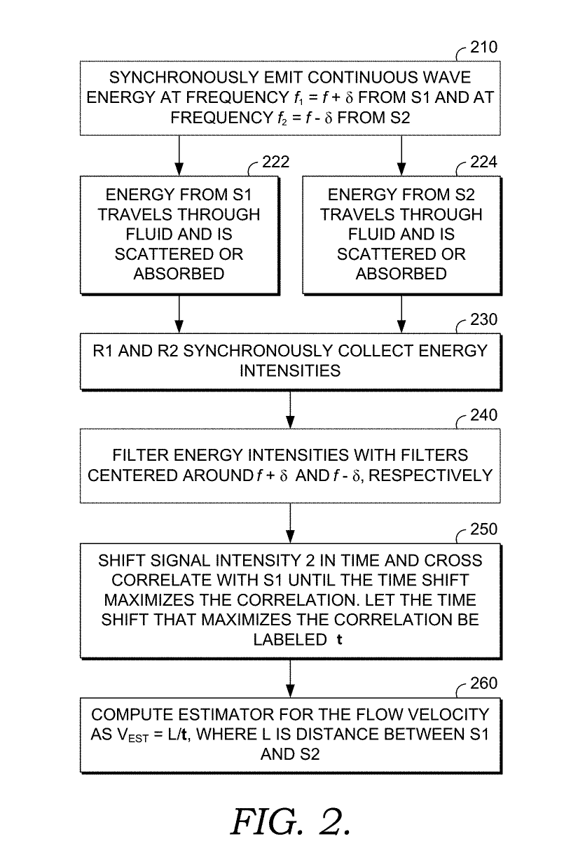

FIG. 2 shows an example of a process flow for determining an estimate of a flow velocity in a pipe. For the example in FIG. 2, the emitters correspond to transducers. In FIG. 2, a first transducer emits 210 a first signal at frequency f+δ while a second transducer emits a signal at frequency f−δ. The first signal is partially scattered and/or adsorbed 222 on the way to the corresponding receiver. Similarly, the second signal is partially scattered and/or adsorbed 224 on the way to the corresponding receiver. The receivers can then collect 230 the partially scattered and/or adsorbed signals. The collected signals can then be processed 240 using filters to produce filtered signals. The first filtered signal, based on use of a filter centered around f+δ, can be referred to as Signal Intensity 1, while the second filtered signal, based on use of a filter centered around f−δ, can be referred to as Signal Intensity 2. Signal Intensity 2 can then be shifted in time by an amount i to determine a cross-correlation 250 that results in a maximum correlation with Signal Intensity 1. The time amount i can then be used to determine an estimated velocity based on the distance L between the transducers and the time τ.

### Examples of Cross-Correlation of Signals

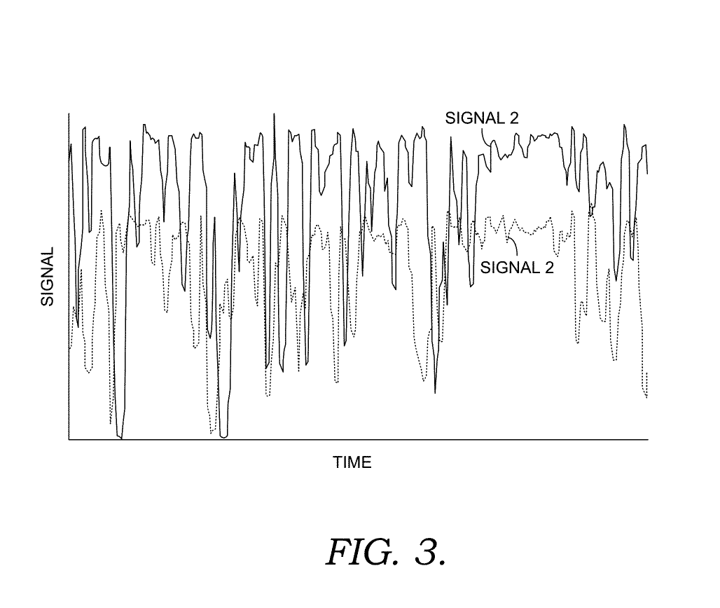

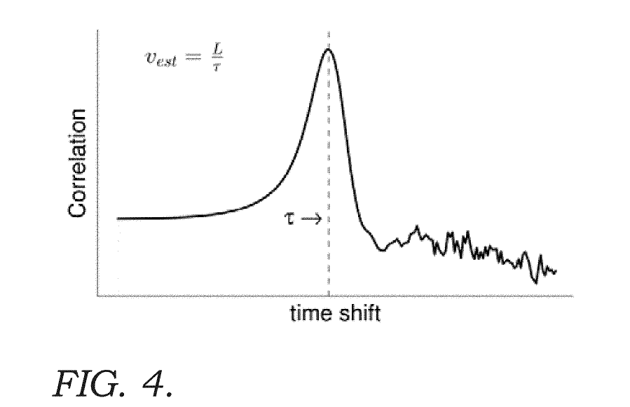

FIG. 3 shows a hypothetical example of signals received by two receivers that are part of emitter/receiver pairs as described herein, such as transducer/receiver pairs. The two signals can be processed to determine a time shift that produces a maximum correlation between the signals. FIG. 4 shows an example of the correlation between the two signals in FIG. 3 as a function of the time shift i for the second signal. As shown in FIG. 4, a distinct maximum in the correlation between the signals can be identified. This maximum corresponds to the time τ, which can then be used to calculate an estimate for the flow velocity in the pipe.

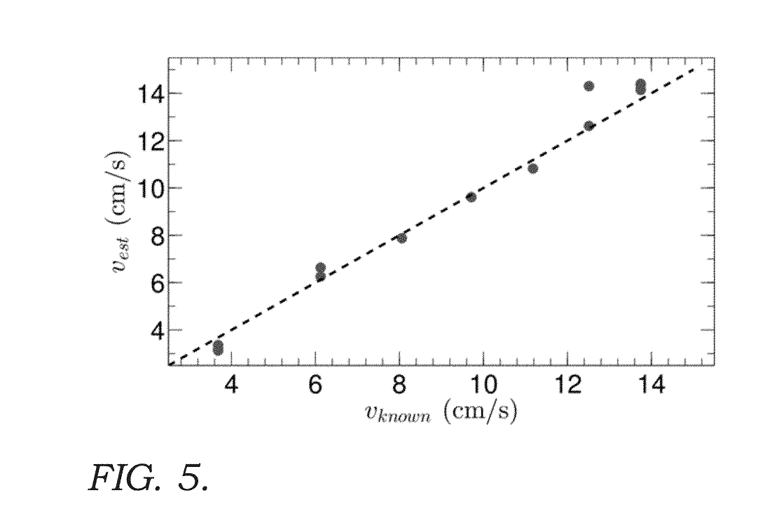

FIG. 5 shows an example of use of the cross-correlation technique for multi-phase flows of known velocity in a pipe. The multi-phase flows in FIG. 5 correspond to laminar liquid flows with suspended gas bubbles as the contrast agents. The x-axis in FIG. 5 corresponds to the known flow velocity, while the y-axis corresponds to estimated flow velocities. The dots in FIG. 5 correspond to estimates of the flow velocity for various known flows based on cross-correlation of filtered ultrasonic signals from transducer/receiver pairs, as described herein. The dashed line corresponds to an ideal correlation where the estimated velocity is equal to the known flow velocity. As shown in FIG. 5, the estimated velocities are similar to the known flow velocities for all of the flow velocities that were tested and shown in FIG. 5.

### Additional Embodiments

Embodiment 1. A method for estimating a flow velocity of a multi-phase flow, comprising: transmitting, by a first emitter, a first signal into a multi-phase flow, the first signal having a frequency f+δ; receiving, by a first receiver, a first received signal comprising a portion of the first signal transmitted through the multi-phase flow; passing the first received signal through a first filter to form a first filtered signal, the first filter being configured for exclusion of signal having a frequency f−δ from the first filtered signal and configured for inclusion of signal having a frequency f+δ in the first filtered signal; transmitting, by a second emitter, a second signal into the multi-phase flow, the second signal having a frequency f−δ, the first emitter and the second emitter being separated by a separation distance; receiving, by a second receiver, a second received signal comprising a portion of the second signal transmitted through the multi-phase flow; passing the second received signal through a second filter to form a second filtered signal, the second filter being configured for exclusion of signal having a frequency f+δ from the second filtered signal and configured for inclusion of signal having a frequency f−δ in the second filtered signal; cross-correlating the first filtered signal with the second filtered signal to determine a time shift corresponding to a maximum correlation between the first filtered signal and the second filtered signal; and estimating a flow velocity of the multi-phase flow based on the separation distance and the determined time shift.

Embodiment 2. The method of Embodiment 1, wherein the first emitter and the second emitter are mounted within a pipe, or wherein the first emitter and the second emitter are mounted on the exterior of a pipe, or wherein at least one of the first emitter and the second emitter is mounted within a vessel.

Embodiment 3. The method of Embodiment 1 or 2, wherein the first emitter comprises a first transducer and the second emitter comprises a second transducer, the first transducer optionally being located on an exterior of a pipe, the second transducer optionally being located on the exterior of the pipe.

Embodiment 4. The method of any of the above embodiments, wherein the second receiver has substantially the same alignment relative to the second emitter as the alignment of the first receiver relative to the first emitter.

Embodiment 5. The method of any of the above embodiments, wherein the first filter comprises at least one of a band-pass filter, a notch filter, and a lock-in filter, a frequency band of the first filter optionally being centered on f+δ; or wherein the second filter comprises at least one of a band-pass filter, a notch filter, and a lock-in filter, a frequency band of the second filter optionally being centered on f−δ; or a combination thereof.

Embodiment 6. The method of any of the above embodiments, wherein the portion of the first signal transmitted through the multi-phase flow comprises a portion of the first signal that has interacted with one or more contrast agents within the multi-phase flow.

Embodiment 7. The method of any of the above embodiments, wherein f+δ comprises a frequency between 20 kHz and 100 MHz (or 100 kHz to 100 MHz), or wherein f−δ comprises a frequency between 20 kHz and 100 MHz (or 100 kHz to 100 MHz), or a combination thereof.

Embodiment 8. The method of any of the above embodiments, wherein a magnitude of δ is 0.01% to 50% of a magnitude off or 0.01% to 25%, or 0.01% to 10%, or 0.1% to 50%, or 0.1% to 10%, or 1.0% to 50%, or 1.0% to 25%.

Embodiment 9. The method of any of the above embodiments, wherein cross-correlation of the first filtered signal and the second filtered signal comprises: dividing the first filtered signal into a first plurality of time windows and dividing the second filtered signal into a second plurality of time windows; and cross-correlating one or more time windows from the first plurality of time windows with one or more corresponding time windows from the second plurality of time windows to generate a series of estimated flow velocities.

Embodiment 10. The method of Embodiment 9, wherein at least one time window from the first plurality of time windows overlaps in time with at least a second time window from the first plurality of time windows; or wherein dividing locations in the second plurality of time windows are offset from dividing locations in the first plurality of time windows; or a combination thereof.

Embodiment 11. A system for estimating a flow velocity of a multi-phase flow, comprising: a first emitter mounted in a first position relative to a pipe or vessel for containing a multi-phase fluid flow, the first emitter configured to generate a first signal having a frequency f+δ; a first receiver mounted in a second position relative to the pipe or vessel for receiving at least a portion of the first signal; a second emitter mounted in a third position relative to the pipe or vessel, the second emitter mounted at a separation distance from the first emitter, the second emitter configured to generate a second ultrasonic signal having a frequency f−δ; a second receiver mounted in a fourth position relative to the pipe or vessel for receiving at least a portion of the second signal; a first filter in signal communication with the first receiver to form a first filtered signal, the first filter being configured for exclusion of signal having a frequency f−δ from the first filtered signal and configured for inclusion of signal having a frequency f+δ in the first filtered signal; a second filter in signal communication with the second receiver to form a second filtered signal, the second filter being configured for exclusion of signal having a frequency f+δ from the second filtered signal and configured for inclusion of signal having a frequency f−δ in the second filtered signal; and a correlator for determining a time shift based on cross-correlation of the first filtered signal and the second filtered signal.

Embodiment 12. The system of Embodiment 11, wherein the first emitter and the second emitter are mounted within the pipe, or wherein the first emitter and the second emitter are mounted on the exterior of the pipe, or wherein at least one of the first emitter and the second emitter is mounted within the vessel.

Embodiment 13. The system of Embodiment 11 or 12, wherein the first filter comprises at least one of a band-pass filter, a notch filter, and a lock-in filter, a frequency band of the first filter optionally being centered on f+δ; or wherein the second filter comprises at least one of a band-pass filter, a notch filter, and a lock-in filter, a frequency band of the second filter optionally being centered on f−δ; or a combination thereof.

Embodiment 14. The system of any of Embodiments 11 to 13, wherein f+δ comprises a frequency between 20 kHz and 100 MHz (or 100 kHz to 100 MHz), or wherein f−δ comprises a frequency between 20 kHz and 100 MHz (or 100 kHz to 100 MHz), or a combination thereof.

Embodiment 15. The system of any of Embodiments 11 to 14, wherein a magnitude of δ is 0.01% to 50% of a magnitude off or 0.01% to 25%, or 0.01% to 10%, or 0.1% to 50%, or 0.1% to 10%, or 1.0% to 50%, or 1.0% to 25%.

Additional Embodiment A. A method for estimating a flow velocity of a multi-phase flow in a pipe, comprising: passing a multi-phase flow through a pipe; generating, by a first transducer, a first ultrasonic signal having a frequency f+δ, the first transducer being located on to an exterior of the pipe; receiving, by a first receiver, a first received signal comprising a portion of the first ultrasonic signal transmitted through the multi-phase flow, the first receiver being located on the exterior of the pipe; passing the first received signal through a first filter to form a first filtered signal, the first filter being configured for exclusion of signal having a frequencyf−δ from the first filtered signal and configured for inclusion of signal having a frequency f+δ in the first filtered signal; generating, by a second transducer mounted on the exterior of the pipe, a second ultrasonic signal having a frequency f−δ, the second transducer being located on an exterior of the pipe, the first transducer and the second transducer being separated by a separation distance; receiving, by a second receiver mounted on the exterior of the pipe, a second received signal comprising a portion of the second ultrasonic signal transmitted through the multi-phase flow, the second receiver having substantially the same alignment relative to the second transducer as the alignment of the first receiver relative to the first transducer; passing the second received signal through a second filter to form a second filtered signal, the second filter being configured for exclusion of signal having a frequency f+δ from the second filtered signal and configured for inclusion of signal having a frequency f−δ in the second filtered signal; cross-correlating the first filtered signal with the second filtered signal to determine a time shift corresponding to a maximum correlation between the first filtered signal and the second filtered signal; and estimating a flow velocity of the multi-phase flow based on the separation distance and the determined time shift.

Additional Embodiment B. A system for estimating a flow velocity of a multi-phase flow in a pipe, comprising: a first transducer mounted on an exterior of a pipe, the first transducer configured to generate a first ultrasonic signal having a frequency f+δ; a first receiver mounted on the exterior of the pipe for receiving at least a portion of the first ultrasonic signal; a second transducer mounted on the exterior of the pipe at a separation distance from the first transducer, the second transducer configured to generate a second ultrasonic signal having a frequency f−δ; a second receiver mounted on the exterior of the pipe for receiving at least a portion of the second ultrasonic signal; a first filter in signal communication with the first receiver to form a first filtered signal, the first filter being configured for exclusion of signal having a frequency f−δ from the first filtered signal and configured for inclusion of signal having a frequency f+δ in the first filtered signal; a second filter in signal communication with the second receiver to form a second filtered signal, the second filter being configured for exclusion of signal having a frequency f+δ from the second filtered signal and configured for inclusion of signal having a frequency f−δ in the second filtered signal; and a correlator for determining a time shift based on cross-correlation of the first filtered signal and the second filtered signal.

Additional Embodiment C. The method or system of any of the above embodiments, to wherein the multi-phase flow comprises a liquid phase and at least one of gas bubbles, solid particles, and an immiscible second liquid phase.

Additional Embodiment D. The system of any of Embodiments 11 to 15, wherein cross-correlation of the first filtered signal and the second filtered signal comprises: dividing the first filtered signal into a first plurality of time windows and dividing the second filtered signal into a second plurality of time windows; and cross-correlating one or more time windows from the first plurality of time windows with one or more corresponding time windows from the second plurality of time windows to generate a series of estimated flow velocities.

Additional Embodiment E. The system of Additional Embodiment D, wherein at least one time window from the first plurality of time windows overlaps in time with at least a second time window from the first plurality of time windows; or wherein dividing locations in the second plurality of time windows are offset from dividing locations in the first plurality of time windows; or a combination thereof.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1. A method for estimating a flow velocity of a multi-phase flow, comprising:
transmitting, by a first emitter, a first signal into a multi-phase flow, the first signal having a frequency f+δ;
receiving, by a first receiver, a first received signal comprising a portion of the first signal transmitted through the multi-phase flow;
passing the first received signal through a first filter to form a first filtered signal, the first filter being configured for exclusion of signal having a frequency f−δ from the first filtered signal and configured for inclusion of signal having a frequency f+δ in the first filtered signal;
transmitting, by a second emitter, a second signal into the multi-phase flow, the second signal having a frequency f−δ, the first emitter and the second emitter being separated by a separation distance;
receiving, by a second receiver, a second received signal comprising a portion of the second signal transmitted through the multi-phase flow;
passing the second received signal through a second filter to form a second filtered signal, the second filter being configured for exclusion of signal having a frequency f+δ from the second filtered signal and configured for inclusion of signal having a frequency f−δ in the second filtered signal;
cross-correlating the first filtered signal with the second filtered signal to determine a time shift corresponding to a maximum correlation between the first filtered signal and the second filtered signal; and
estimating a flow velocity of the multi-phase flow based on the separation distance and the determined time shift.

2. The method of claim 1, wherein the first emitter and the second emitter are mounted within a pipe, or wherein the first emitter and the second emitter are mounted on the exterior of a pipe.

3. The method of claim 1, wherein at least one of the first emitter and the second emitter is mounted within a vessel.

4. The method of claim 1, wherein the first emitter comprises a first transducer and the second emitter comprises a second transducer.

5. The method of claim 1, wherein the second receiver has substantially the same alignment relative to the second emitter as the alignment of the first receiver relative to the first emitter.

6. The method of claim 1, wherein the first filter comprises at least one of a band-pass filter, a notch filter, and a lock-in filter; or wherein the second filter comprises at least one of a band-pass filter, a notch filter, and a lock-in filter; or a combination thereof.

7. The method of claim 1, wherein the portion of the first signal transmitted through the multi-phase flow comprises a portion of the first signal that has interacted with one or more contrast agents within the multi-phase flow.

8. The method of claim 1, wherein a frequency band of the first filter is centered on f+δ, or wherein a frequency band of the second filter is centered on f−δ, or a combination thereof.

9. The method of claim 1, wherein the multi-phase flow comprises a liquid phase and at least one of gas bubbles, solid particles, and an immiscible second liquid phase.

10. The method of claim 1, wherein f+δ comprises a frequency between 20 kHz and 100 MHz, or wherein f−δ comprises a frequency between 20 kHz and 100 MHz, or a combination thereof.

11. The method of claim 1, wherein a magnitude of δ is 0.01% to 50% of a magnitude off

12. The method of claim 1, wherein cross-correlation of the first filtered signal and the second filtered signal comprises:
dividing the first filtered signal into a first plurality of time windows and dividing the second filtered signal into a second plurality of time windows; and
cross-correlating one or more time windows from the first plurality of time windows with one or more corresponding time windows from the second plurality of time windows to generate a series of estimated flow velocities.

13. The method of claim 12, wherein at least one time window from the first plurality of time windows overlaps in time with at least a second time window from the first plurality of time windows.

14. The method of claim 12, wherein dividing locations in the second plurality of time windows are offset from dividing locations in the first plurality of time windows.

15. A method for estimating a flow velocity of a multi-phase flow in a pipe, comprising:
passing a multi-phase flow through a pipe;
generating, by a first transducer, a first ultrasonic signal having a frequency f+δ, the first transducer being located on an exterior of the pipe;
receiving, by a first receiver, a first received signal comprising a portion of the first ultrasonic signal transmitted through the multi-phase flow, the first receiver being located on the exterior of the pipe;
passing the first received signal through a first filter to form a first filtered signal, the first filter being configured for exclusion of signal having a frequency f−δ from the first filtered signal and configured for inclusion of signal having a frequency f+δ in the first filtered signal;
generating, by a second transducer mounted on the exterior of the pipe, a second ultrasonic signal having a frequency f−δ, the second transducer being located on an exterior of the pipe, the first transducer and the second transducer being separated by a separation distance;
receiving, by a second receiver mounted on the exterior of the pipe, a second received signal comprising a portion of the second ultrasonic signal transmitted through the multi-phase flow, the second receiver having substantially the same alignment relative to the second transducer as the alignment of the first receiver relative to the first transducer;
passing the second received signal through a second filter to form a second filtered signal, the second filter being configured for exclusion of signal having a frequency f+δ from the second filtered signal and configured for inclusion of signal having a frequency f−δ in the second filtered signal;
cross-correlating the first filtered signal with the second filtered signal to determine a time shift corresponding to a maximum correlation between the first filtered signal and the second filtered signal; and
estimating a flow velocity of the multi-phase flow based on the separation distance and the determined time shift.

16. A system for estimating a flow velocity of a multi-phase flow, comprising:
a first emitter mounted in a first position relative to a pipe or vessel for containing a multi-phase fluid flow, the first emitter configured to generate a first signal having a frequency f+δ;
a first receiver mounted in a second position relative to the pipe or vessel for receiving at least a portion of the first signal;
a second emitter mounted in a third position relative to the pipe or vessel, the second emitter mounted at a separation distance from the first emitter, the second emitter configured to generate a second ultrasonic signal having a frequency f−δ;
a second receiver mounted in a fourth position relative to the pipe or vessel for receiving at least a portion of the second signal;
a first filter in signal communication with the first receiver to form a first filtered signal, the first filter being configured for exclusion of signal having a frequency f−δ from the first filtered signal and configured for inclusion of signal having a frequency f+δ in the first filtered signal;
a second filter in signal communication with the second receiver to form a second filtered signal, the second filter being configured for exclusion of signal having a frequency f+δ from the second filtered signal and configured for inclusion of signal having a frequency f−δ in the second filtered signal; and
a correlator for determining a time shift based on cross-correlation of the first filtered signal and the second filtered signal.

17. The system of claim 16, wherein the first emitter and the second emitter are mounted within the pipe, or wherein the first emitter and the second emitter are mounted on the exterior of the pipe.

18. The system of claim 16, wherein at least one of the first emitter and the second emitter is mounted within the vessel.

19. The system of claim 16, wherein the first filter comprises at least one of a band-pass filter, a notch filter, and a lock-in filter; or wherein the second filter comprises at least one of a band-pass filter, a notch filter, and a lock-in filter; or a combination thereof.

20. A system for estimating a flow velocity of a multi-phase flow in a pipe, comprising:
a first transducer mounted on an exterior of a pipe, the first transducer configured to generate a first ultrasonic signal having a frequency f+δ;
a first receiver mounted on the exterior of the pipe for receiving at least a portion of the first ultrasonic signal;
a second transducer mounted on the exterior of the pipe at a separation distance from the first transducer, the second transducer configured to generate a second ultrasonic signal having a frequency f−δ;
a second receiver mounted on the exterior of the pipe for receiving at least a portion of the second ultrasonic signal;
a first filter in signal communication with the first receiver to form a first filtered signal, the first filter being configured for exclusion of signal having a frequency f−δ from the first filtered signal and configured for inclusion of signal having a frequency f+δ in the first filtered signal;
a second filter in signal communication with the second receiver to form a second filtered signal, the second filter being configured for exclusion of signal having a frequency f+δ from the second filtered signal and configured for inclusion of signal having a frequency f−δ in the second filtered signal; and
a correlator for determining a time shift based on cross-correlation of the first filtered signal and the second filtered signal.
